(19) United States
(12) Patent Application Publication
(10) Pub. No.: US 2022/0203528 A1
(43) Pub. Date: Jun. 30, 2022

(54) Robot System

(71) Applicant: Seiko Epson Corporation, Tokyo (JP)

(72) Inventor: Daisuke SATO, Matsumoto (JP)

(21) Appl. No.: 17/560,477

(22) Filed: Dec. 23, 2021

(30) Foreign Application Priority Data
Dec. 25, 2020 (JP) 2020-216485

(51) Int. Cl. B25J 9/16; B25J 13/08

(52) U.S. Cl. CPC B25J 9/1653; B25J 13/088; B25J 9/1674; B25J 9/1602

(57) ABSTRACT

A robot system includes a robot arm, a driving control section configured to control driving of the robot arm based on position information output by a first position detecting section and a second position detecting section, a monitoring section configured to determine, based on the position information, whether the operation of the robot arm is normal, a first communication line for coupling the driving control section and the first position detecting section and coupling the driving control section and the second position detecting section to perform half duplex communication, and a second communication line for coupling the monitoring section and the driving control section, coupling the monitoring section and the first position detecting section, coupling the monitoring section and the second position detecting section to perform the half duplex communication. The driving control section performs first communication with the first position detecting section via the first communication line and second communication with the second position detecting section via the second communication line in a temporally overlapping manner.

The present application is based on, and claims priority from JP Application Serial Number 2020-216485, filed Dec. 25, 2020, the disclosure of which is hereby incorporated by reference herein in its entirety.

### BACKGROUND

### 1. Technical Field

The present disclosure relates to a robot system.

### 2. Related Art

In recent years, in factories, automation of work manually performed in the past has been accelerated by various robots and peripheral devices of the robots because of a steep rise in personal expenses and labor shortages. For example, a robot described in JP-A-2002-354859 (Patent Literature 1) includes a robot arm, a plurality of motors including encoders that drive the robot arm, servo drives respectively coupled to the motors, a controller that controls conditions of energization to the servo drives, and a speed monitoring device that monitors the operations of the motors.

In Patent Literature 1, the speed monitoring device is coupled to each of the servo drives by dedicated wire. The controller is coupled to one of the servo drives by a wire and the servo drives are coupled by a plurality of wires to be respectively coupled in series.

However, in the configuration of Patent Literature 1, since the speed monitoring device is coupled to each of the servo drives by the dedicated wire, the number of wires increases. Further, in the configuration of Patent Literature 1, it takes time until the controller and the speed monitoring device finish acquiring position information of the motors.

### SUMMARY

A robot system according to an aspect of the present disclosure includes: a robot arm including a first arm, a second arm, a first position detecting section configured to detect a position of the first arm, and a second position detecting section configured to detect a position of the second arm; a driving control section configured to control driving of the robot arm based on position information output by the first position detecting section and the second position detecting section; a monitoring section configured to determine, based on the position information, whether an operation of the robot arm is normal; a first communication line for coupling the driving control section and the first position detecting section and coupling the driving control section and the second position detecting section to perform half duplex communication; and a second communication line for coupling the monitoring section and the driving control section, coupling the monitoring section and the first position detecting section, coupling the monitoring section and the second position detecting section to perform the half duplex communication. The driving control section performs first communication with the first position detecting section via the first communication line and second communication with the second position detecting section via the second communication line in a temporally overlapping manner.

### BRIEF DESCRIPTION OF THE DRAWINGS

FIG. 1 is a schematic configuration diagram of a first embodiment of a robot system according to the present disclosure.

FIG. 2 is a functional block diagram of the robot system shown in FIG. 1.

FIG. 3 is a functional block diagram of an encoder shown in FIG. 1.

FIG. 4 is a functional block diagram of a driving control section and a monitoring section shown in FIG. 1.

FIG. 5 is a diagram for explaining a coupling scheme for the encoder, the driving control section, and the monitoring section shown in FIG. 1.

FIG. 6 is a timing chart showing communication timings of the encoder, the driving control section, and the monitoring section shown in FIG. 1.

FIG. 7 is a diagram for explaining a coupling scheme for an encoder, a driving control section, and a monitoring section included in a second embodiment of the robot system according to the present disclosure.

FIG. 8 is a functional block diagram of the encoder shown in FIG. 7.

FIG. 9 is a functional block diagram of the driving control section and the monitoring section shown in FIG. 7.

FIG. 10 is a timing chart showing communication timings of the encoder, the driving control section, and the monitoring section shown in FIG. 7.

FIG. 11 is a diagram for explaining a coupling scheme for an encoder, a driving control section, and a monitoring section included in a third embodiment of the robot system according to the present disclosure.

FIG. 12 is a timing chart showing communication timings of an encoder, a driving control section, and a monitoring section included in a fourth embodiment of the robot system according to the present disclosure.

### DESCRIPTION OF EXEMPLARY EMBODIMENTS

A robot system according to the present disclosure is explained in detail below based on preferred embodiments shown in the accompanying drawings.

### First Embodiment

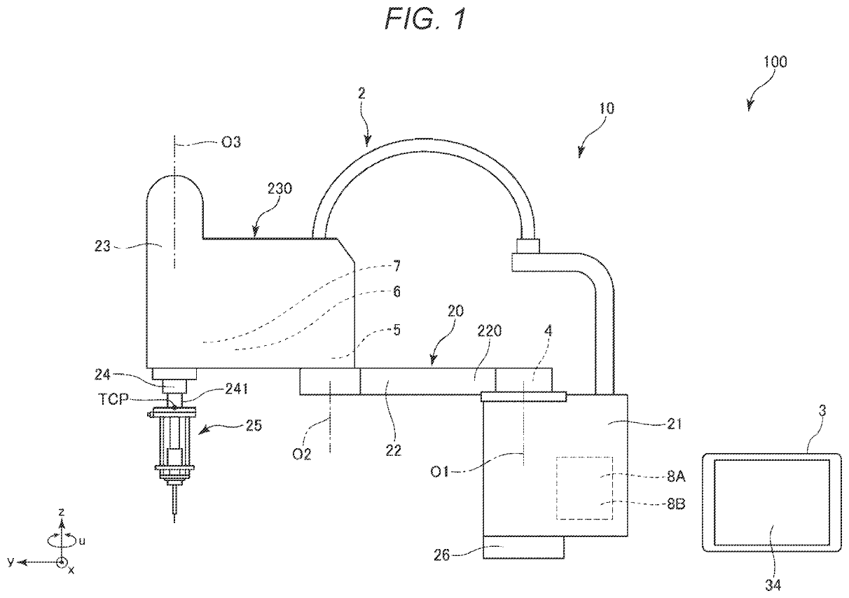

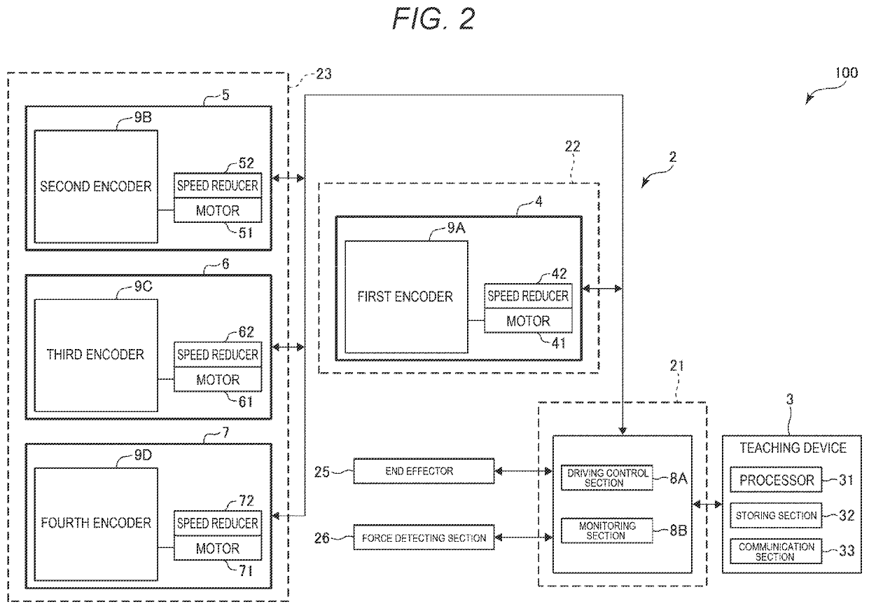

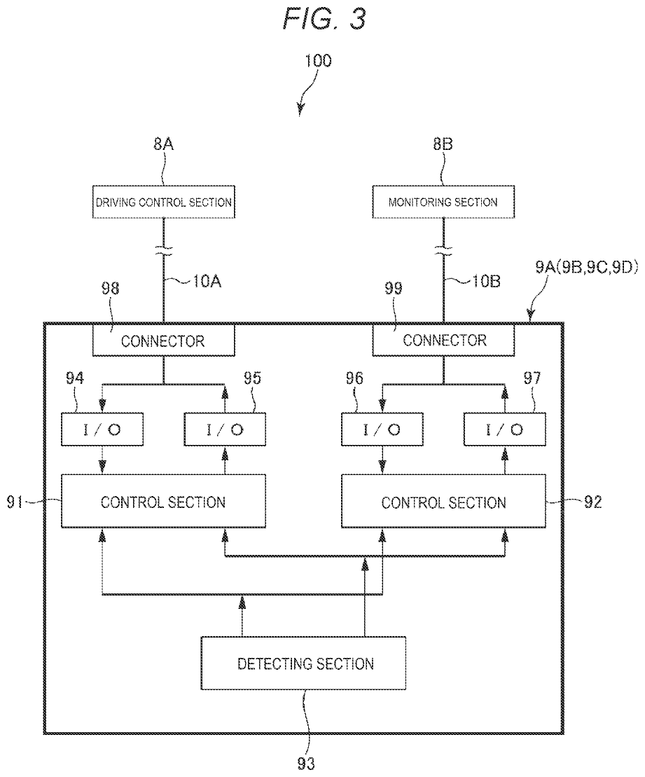

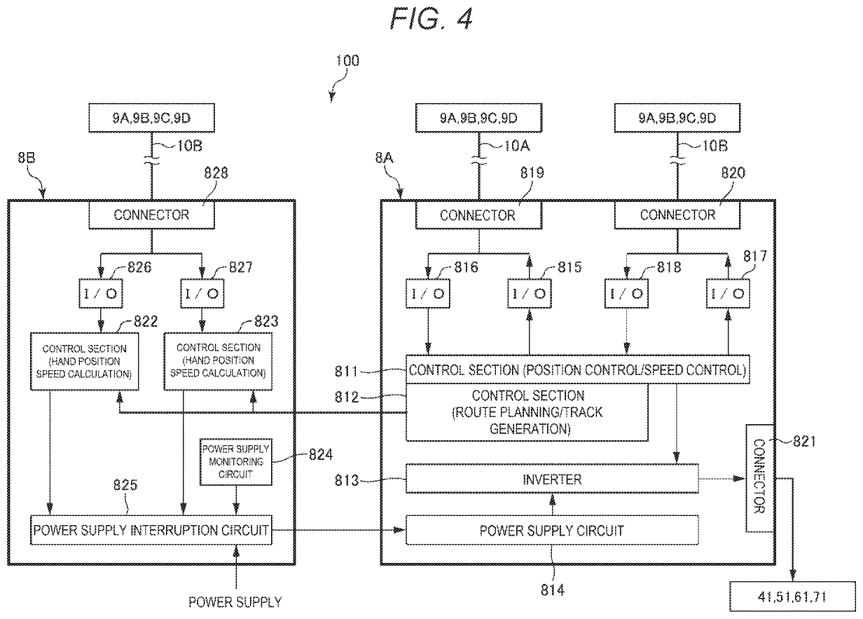

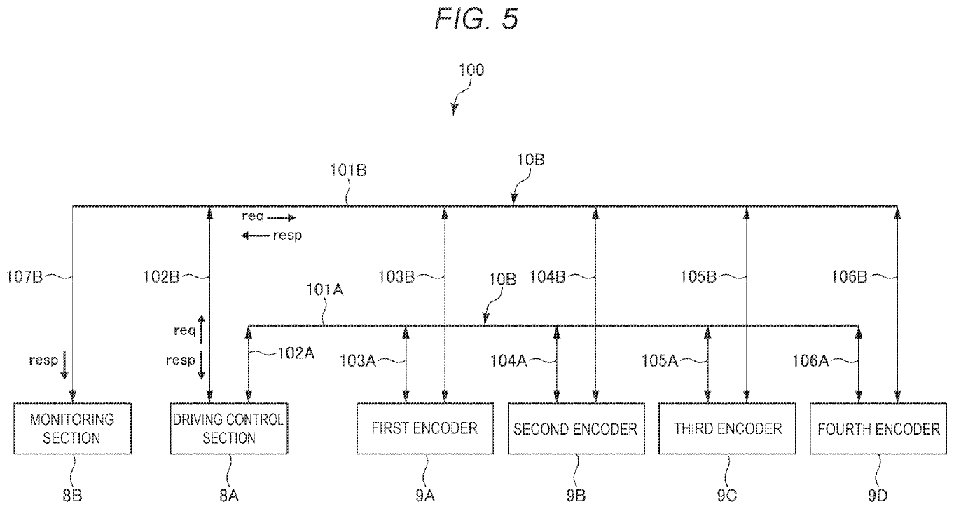

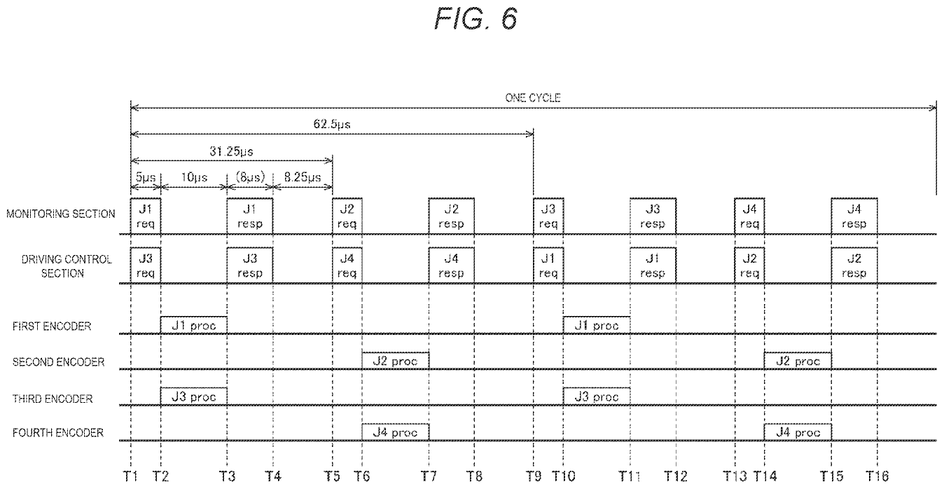

FIG. 1 is a schematic configuration diagram of a first embodiment of the robot system according to the present disclosure. FIG. 2 is a functional block diagram of the robot system shown in FIG. 1. FIG. 3 is a functional block diagram of an encoder shown in FIG. 1. FIG. 4 is a functional block diagram of a driving control section and a monitoring section shown in FIG. 1. FIG. 5 is a diagram for explaining a coupling scheme for the encoder, the driving control section, and the monitoring section shown in FIG. 1. FIG. 6 is a timing chart showing communication timings of the encoder, the driving control section, and the monitoring section shown in FIG. 1.

In FIG. 1, for convenience of explanation, an x axis, a y axis, and a z axis are shown as three axes orthogonal to one another. In the following explanation, a direction parallel to the x axis is referred to as “x-axis direction” as well, a direction parallel to the y axis is referred to as “y-axis direction” as well, and a direction parallel to the z axis is referred to as “z-axis direction” as well. A direction around the z axis and a direction around an axis parallel to the z axis are referred to as “u direction” as well.

In the following explanation, the distal end side, that is, the upper side of an arrow of the z axis in FIG. 1 is referred to as “upper” or “above” as well and the proximal end side, that is, the lower side of the arrow is referred to as “lower” or “below” as well. About a robot arm 20, a base 21 side in FIG. 1 is referred to as “proximal end” and the opposite side of the base 21 side, that is, an end effector 25 side is referred to as “distal end”. The z-axis direction, that is, the up-down direction in FIG. 1 is represented as “vertical direction” and the x-axis direction and the y-axis direction are represented as “horizontal direction”.

A robot system 100 shown in FIGS. 1 and 2 is an apparatus used in work such as holding, conveyance, assembly, and a test of workpieces such as electronic component and electronic equipment. The robot system 100 includes a robot 2 and a teaching device 3 that teaches an operation program to the robot 2.

First, the robot 2 is explained.

In a configuration shown in FIG. 1, the robot 2 is a horizontal articulated robot, that is, a SCARA robot. As shown in FIG. 1, the robot 2 includes a base 21, a robot arm 20 coupled to the base 21, an end effector 25, a force detecting section 26, and a driving control section 8A that controls the operations of these sections.

The base 21 is a portion that supports the robot arm 20. The driving control section 8A explained below is incorporated in the base 21. The origin of a robot coordinate system is set in any portion of the base 21. The x axis, the y axis, and the z axis shown in FIG. 1 are axes of the robot coordinate system.

The robot arm 20 includes an arm 22, an arm 23, and an arm 24, which is a work head.

The robot 2 is not limited to the configuration shown in FIG. 1. The number of arms may be two or may be four or more.

The robot 2 includes a driving unit 4 that rotates the arm 22 with respect to the base 21, a driving unit 5 that rotates the arm 23 with respect to the arm 22, a u-driving unit 6 that rotates a shaft 241 of the arm 24 with respect to the arm 23, and a z-driving unit 7 that moves the shaft 241 in the z-axis direction with respect to the arm 23.

As shown in FIGS. 1 and 2, the driving unit 4 is incorporated in a housing 220 of the arm 22 and includes a motor 41 that generates a driving force, a speed reducer 42 that decelerates the driving force of the motor 41, and a first encoder 9A that detects a rotation amount of a rotating shaft of the motor 41 or the speed reducer 42. The rotation amount means one or both of an angle from a reference position in one rotation and the number of rotations.

The driving unit 5 is incorporated in a housing 230 of the arm 23 and includes a motor 51 that generates a driving force, a speed reducer 52 that decelerates the driving force of the motor 51, and a second encoder 9B that detects a rotation amount of a rotating shaft of the motor 51 or the speed reducer 52.

The u-driving unit 6 is incorporated in the housing 230 of the arm 23 and includes a motor 61 that generates a driving force, a speed reducer 62 that decelerates the driving force of the motor 61, and a third encoder 9C that detects a rotation amount of a rotating shaft of the motor 61 or the speed reducer 62.

The z-driving unit 7 is incorporated in the housing 230 of the arm 23 and includes a motor 71 that generates a driving force, a speed reducer 72 that decelerates the driving force of the motor 71, and a fourth encoder 9D that detects a rotation amount of a rotating shaft of the motor 71 or the speed reducer 72.

As the motor 41, the motor 51, the motor 61, and the motor 71, for example, servomotors such as an AC servomotor and a DC servomotor can be used. The motor 41, the motor 51, the motor 61, and the motor 71 are respectively coupled to not-shown motor drivers corresponding to the motors and are controlled by the driving control section 8A via the motor drivers.

As the speed reducer 42, the speed reducer 52, the speed reducer 62, and the speed reducer 72, for example, a speed reducer of a planetary gear type and a wave gear device can be used.

The base 21 is fixed to a not-shown floor surface by bolts or the like via the force detecting section 26. The arm 22 is coupled to the upper end portion of the base 21. The arm 22 is capable of rotating with respect to the base 21 around a first axis O1 extending along the vertical direction. When the driving unit 4, which rotates the arm 22, is driven, the arm 22 rotates with respect to the base 21 in a horizontal plane around the first axis O1. In this rotation, a rotation amount of the arm 22 with respect to the base 21 can be detected by the first encoder 9A.

The arm 23 is coupled to the distal end portion of the arm 22. The arm 23 is capable of rotating with respect to the arm 22 around a second axis O2 extending along the vertical direction. The axial direction of the first axis O1 and the axial direction of the second axis O2 are the same. That is, the second axis O2 is parallel to the first axis O1. When the driving unit 5, which rotates the arm 23, is driven, the arm 23 rotates with respect to the arm 22 in the horizontal plane around the second axis O2. In this rotation, a rotation amount of the arm 23 with respect to the arm 22 can be detected by the second encoder 9B.

The arm 24 is set and supported at the distal end portion of the arm 23. The arm 24 includes the shaft 241. The shaft 241 is capable of rotating with respect to the arm 23 around a third axis O3 extending along the vertical direction and is capable of moving in the up-down direction. The shaft 241 is an arm at the most distal end of the robot arm 20.

When the u-driving unit 6, which rotates the shaft 241, is driven, the shaft 241 rotates around the z axis. In this rotation, a rotation amount of the shaft 241 with respect to the arm 23 can be detected by the third encoder 9C.

When the z-driving unit 7, which moves the shaft 241 in the z-axis direction, is driven, the shaft 241 moves in the up-down direction, that is, the z-axis direction. In this movement, a movement amount in the z-axis direction of the shaft 241 with respect to the arm 23 can be detected by the fourth encoder 9D.

In the robot 2, the distal end of the shaft 241 is set as a control point TCP. A distal end coordinate system having the control point TCP as the origin is set. Calibration of the distal end coordinate system with the robot coordinate system explained above is already finished. A position in the distal end coordinate system can be converted into a position in the robot coordinate system. Consequently, the position of the control point TCP can be specified in the robot coordinate system.

Various end effectors are detachably coupled to the distal end portion of the shaft 241. The end effectors are not particularly limited. Examples of the end effectors include an end effector that grips an object to be conveyed, an end effector that machines a workpiece, and an end effector used for inspection. In this embodiment, the end effector 25 is detachably coupled to the distal end portion of the shaft 241.

In this embodiment, the end effector 25 is not a constituent element of the robot 2. However, a part or the entire end effector 25 may be a constituent element of the robot 2.

As shown in FIG. 1, the force detecting section 26 detects force applied to the robot 2, that is, force applied to the robot arm 20 and the base 21. In this embodiment, the force detecting section 26 is provided below the base 21, that is, in a z-axis negative direction and supports the base 21 from below.

The force detecting section 26 is configured by a piezoelectric body such as crystal and can be configured to include a plurality of elements that output electric charges when receiving an external force. The driving control section 8A can convert, according to an amount of the electric charges, the electric charges into a value of an external force received by the robot arm 20. Such a piezoelectric body is capable of adjusting, according to a setting direction of the piezoelectric body, a direction in which the piezoelectric body generates electric charges when receiving an external force.

The first to forth encoders 9A to 9D are explained.

The first to fourth encoders 9A to 9D have the same configuration except that the first to fourth encoders 9A to 9D detect rotation amounts of different motors. Therefore, the first encoder 9A is representatively explained below.

As shown in FIG. 3, the first encoder 9A includes a control section 91, a control section 92, a detecting section 93, an I/O interface 94, an I/O interface 95, an I/O interface 96, an I/O interface 97, a connector 98, and a connector 99.

The control section 91 and the control section 92 include processors and memories. The processors are configured by, for example, CPUs (Central Processing Units) and can read and execute various programs and the like stored in the memories. The memories store various programs and the like executable by the processors. Examples of the memories include a volatile memory such as a RAM (Random Access Memory), a nonvolatile memory such as a ROM (Read Only Memory), and a memory including a volatile region and a nonvolatile region.

The detecting section 93 includes, for example, a not-shown scale coupled to the rotating shaft of the motor 41 and a not-shown optical element that reads rotation of the scale. The detecting section 93 outputs a signal corresponding to a rotation amount of the scale to the control section 91 and the control section 92. A detection scheme in the detecting section 93 may be any scheme such as an optical type or a magnetic type.

In this embodiment, the detecting section 93 outputs detection results in different detection schemes to the control section 91 and the control section 92. Consequently, it is possible to improve reliability of the first to fourth encoders 9A to 9D.

The control section 91 and the control section 92 receive a signal output from the detecting section 93 and calculate a rotation amount of the motor 41. A result of the calculation is position information of the arm 22.

The I/O interface 94 performs communication with the driving control section 8A via a first communication line 10A, receives a request signal, and inputs the request signal to the control section 91. The request signal is a signal output by the driving control section 8A to request a position information.

The I/O interface 95 performs communication with the driving control section 8A via the first communication line 10A and transmits a response signal, that is, a position signal output from the control section 91 to the driving control section 8A as an output signal.

The I/O interface 96 performs communication with a monitoring section 8B via a second communication line 10B, receives a request signal, and inputs the request signal to the control section 92.

The I/O interface 97 performs communication with the monitoring section 8B via the second communication line 10B and transmits a response signal, that is, a position signal output from the control section 92 to the monitoring section 8B as an output signal.

The I/O interfaces 94 to 97 perform packet communication with the driving control section 8A or the monitoring section 8B. A communication scheme of the packet communication is serial communication. That is, the first communication line 10A and the second communication line 10B are communication lines for performing half duplex communication for performing transmission and reception in a time division manner. Consequently, compared with a configuration in which the first communication line 10A and the second communication line 10B are communication lines for performing parallel communication, it is possible to reduce the number of wires of the first communication line 10A and the second communication line 10B.

The connector 98 is a coupling section to which the first communication line 10A is coupled. The connector 98 is a connector of a standard corresponding to a wire for performing serial communication.

The connector 99 is a coupling section to which the second communication line 10B is coupled. The connector 99 is a connector of the standard corresponding to the wire for performing the serial communication.

The driving control section 8A is explained.

As shown in FIG. 4, the driving control section 8A controls the operation of the robot arm 20 based on position information received from the first to fourth encoders 9A to 9D. Specifically, the driving control section 8A includes a control section 811, a control section 812, an inverter 813, a power supply circuit 814, an I/O interface 815, an I/O interface 816, an I/O interface 817, an I/O interface 818, a connector 819, a connector 820, and a connector 821.

The control section 811 and the control section 812 respectively include processors and memories. The processors are configured by, for example, CPUs and can read and execute various programs stored in the memories. The memories store various programs and the like executable by the processors.

The control section 811 performs position control and speed control for the arms 22 to 24. That is, the control section 811 generates and outputs a request signal and receives a response signal. The control section 811 outputs the received response signal to the control section 812.

The control section 812 generates, based on, for example, teaching information input from the teaching device 3, a route plan of the robot arm 20 and a track of the robot arm 20. The control section 812 determines, based on arm position information input from the control section 811 and programs stored in the memories, how the arms 22 to 24 are moved to target positions and at which degree of speed the arms 22 to 24 are driven and outputs a signal concerning a position command for the target position and a speed command for the speed to the control section 811.

The control section 811 converts, based on the position command and the speed command input to the control section 811, electric power supplied from the power supply circuit 814 into an alternating current with the inverter 813 and controls conditions for energization to the motor 41, the motor 51, the motor 61, and the motor 71.

The control section 812 outputs the signal concerning the position command and the speed command to the control section 811 and outputs the signal to the monitoring section 8B.

The I/O interface 815 performs communication with the first encoder 9A, the second encoder 9B, the third encoder 9C, and the fourth encoder 9D via the first communication line 10A and transmits request signals for requesting position information respectively to the first encoder 9A, the second encoder 9B, the third encoder 9C, and the fourth encoder 9D. The request signals transmitted by the I/O interface 815 are signals generated by the control section 811 and signals for requesting the first encoder 9A, the second encoder 9B, the third encoder 9C, and the fourth encoder 9D to transmit the position information to the driving control section 8A and the monitoring section 8B.

The I/O interface 816 performs communication with the first encoder 9A, the second encoder 9B, the third encoder 9C, and the fourth encoder 9D via the first communication line 10A, receives response signals of the position information, and outputs the response signals to the control section 811.

The I/O interface 817 performs communication with the first encoder 9A, the second encoder 9B, the third encoder 9C, and the fourth encoder 9D via the second communication line 10B and transmits request signals for requesting position information respectively to the first encoder 9A, the second encoder 9B, the third encoder 9C, and the fourth encoder 9D.

The I/O interface 818 performs communication with the first encoder 9A, the second encoder 9B, the third encoder 9C, and the fourth encoder 9D via the second communication line 10B, receives response signals of the position information, and outputs the response signals to the control section 811.

The connector 819 is a coupling section to which the first communication line 10A is coupled. The connector 819 is a connector of the standard corresponding to the wire for performing the serial communication.

The connector 820 is a coupling section to which the second communication line 10B is coupled. The connector 820 is a connector of the standard corresponding to the wire for performing the serial communication.

The connector 821 is a coupling section including a plurality of ports to which a signal line to a motor, a power line, and the like are coupled.

As shown in FIGS. 1 and 2, in this embodiment, the driving control section 8A is incorporated in the base 21. However, the driving control section 8A is not limited to this configuration and may be set in any position on the outer side of the base 21.

The monitoring section 8B is explained.

As shown in FIG. 4, the monitoring section 8B has a function of determining whether the position information received from the first to fourth encoders 9A to 9D is normal. The monitoring section 8B includes a control section 822, a control section 823, a power supply monitoring circuit 824, a power supply interruption circuit 825, an I/O interface 826, an I/O interface 827, and a connector 828.

The control section 822 and the control section 823 respectively include processors and memories. The processors are configured by, for example, CPUs and can read and execute various programs and the like stored in the memories. The memories store various programs and the like executable by the processors.

The control section 822 calculates a position of the control point TCP and speed of the control point TCP based on position information received via the I/O interface 826. The control section 822 determines whether the position information received via the I/O interface 826 and information of the position command input from the control section 812 of the driving control section 8A coincide. That is, the control section 822 determines, based on position commands to the arms 22 to 24, whether the arms 22 to 24 have moved as commanded. When determining that the position information and the information do not coincide, the control section 822 regards that the operation of the robot 2 is abnormal and transmits a command to the power supply interruption circuit 825 to stop supply of electric power to the robot arm 20. The control section 822 determines whether the calculated speed of the control point TCP is equal to or lower than predetermined speed. When determining that the speed of the control point TCP exceeds the predetermined speed, the control section 822 regards that the operation of the robot 2 is abnormal and transmits a command to the power supply interruption circuit 825 to stop the supply of the electric power to the robot arm 20.

In this way, when determining that the operation of the robot arm 20 is abnormal, the monitoring section 8B stops the operation of the robot arm 20. Consequently, it is possible to improve safety.

The control section 823 calculates a position of the control point TCP and speed of the control point TCP based on the position information received via the I/O interface 827. The control section 823 determines whether the position information received via the I/O interface 827 and information of the position command input from the control section 812 of the driving control section 8A coincide. This determination and the subsequent control operation are the same as the determination and the control operation by the control section 822. The two control sections 822 and 823 perform monitoring each other to determine whether the control sections 822 and 823 are normal.

In this way, the two control sections 822 and 823 monitor whether the operation of the robot arm 20 is normal. Consequently, it is possible to improve safety in causing the robot 2 to operate.

The power supply monitoring circuit 824 determines whether electric power supplied from a power supply is normal. When determining that the electric power supplied from the power supply is abnormal, the power supply monitoring circuit 824 transmits a command to the power supply interruption circuit 825 to stop the supply of the electric power to the robot arm 20. Consequently, it is possible to prevent, for example, excessive electric power from being supplied to the sections of the robot arm 20. Accordingly, it is possible to improve the safety in causing the robot 2 to operate.

The I/O interface 826 performs communication with the first encoder 9A, the second encoder 9B, the third encoder 9C, and the fourth encoder 9D via the second communication line 10B, receives response signals of position information, and outputs the response signals to the control section 822.

The I/O interface 827 performs communication with the first encoder 9A, the second encoder 9B, the third encoder 9C, and the fourth encoder 9D via the second communication line 10B, receives response signals of position information, and outputs the response signals to the control section 823.

The connector 828 is a coupling section to which the second communication line 10B is coupled. The connector 828 is a connector of the standard corresponding to the wire for performing the serial communication.

The teaching device 3 is explained.

As shown in FIGS. 1 and 2, the teaching device 3 has a function of controlling the operation of the robot arm 20 and includes a processor 31, a storing section 32, a communication section 33, and a display section 34. The teaching device 3 is not particularly limited. Examples of the teaching device 3 include a tablet terminal, a personal computer, and a smartphone.

The processor 31 is configured by a CPU or the like and reads out and executes various programs such as a teaching program stored in the storing section 32. The teaching program may be a teaching program generated by the teaching device 3, may be a teaching program stored from an external recording medium such as a CD-ROM, or may be a teaching program stored via a network or the like.

A signal generated by the processor 31 is transmitted to the driving control section 8A of the robot 2 via the communication section 33. Consequently, the robot arm 20 can execute predetermined work under predetermined conditions. The processor 31 controls driving of the display section 34 shown in FIG. 1.

The storing section 32 stores various programs and the like executable by the processor 31. Examples of the storing section 32 include a volatile memory such as a RAM, a nonvolatile memory such as a ROM (Read Only Memory), and a detachable external storage device.

The communication section 33 performs transmission and reception of signals to and from the driving control section 8A using an external interface such as a wired LAN or a wireless LAN.

The display section 34 is configured by various displays including display screens. In this embodiment, as an example, the display section 34 is explained as a touch panel type, that is, a configuration including a display function and an input operation function. When an operator touches the display screen, the processor 31 performs control for switching the display screen to predetermined display.

However, the display section 34 is not limited to such a configuration and may be a configuration separately including an input operation section. In this case, examples of the input operation section include a mouse and a keyboard. The touch panel and the mouse and the keyboard may be used together.

As shown in FIG. 5, the first to fourth encoders 9A to 9D and the driving control section 8A and the monitoring section 8B are coupled by the first communication line 10A and the second communication line 10B. The first communication line 10A includes a bus 101A and a wire 102A, a wire 103A, a wire 104A, a wire 105A, and a wire 106A coupled to the bus 101A. The second communication line 10B includes a bus 101B and a wire 102B, a wire 103B, a wire 104B, a wire 105B, a wire 106B, and a wire 107B coupled to the bus 101B.

The wire 102A couples the bus 101A and the driving control section 8A. The wire 103A couples the bus 101A and the first encoder 9A. The wire 104A couples the bus 101A and the second encoder 9B. The wire 105A couples the bus 101A and the third encoder 9C. The wire 106A couples the bus 101A and the fourth encoder 9D.

The wire 102B couples the bus 101B and the driving control section 8A. The wire 103B couples the bus 101B and the first encoder 9A. The wire 104B couples the bus 101B and the second encoder 9B. The wire 105B couples the bus 101B and the third encoder 9C. The wire 106B couples the bus 101B and the fourth encoder 9D. The wire 107B couples the bus 101B and the monitoring section 8B.

Communication timings of the first to fourth encoders 9A to 9D, the driving control section 8A, and the monitoring section 8B are explained with reference to FIG. 5 and the timing chart of FIG. 6. In FIG. 6, “req” indicates a request signal and “resp” indicates a response signal. Actually, the driving control section 8A requests the monitoring section 8B to transmit a response signal and transmits the request signal “req” in the timing chart of the monitoring section 8B to the encoders. However, to facilitate understanding of explanation, “req” is shown in the timing chart of the monitoring section 8B.

In FIGS. 6, 7, and 10 to 12, “J1” indicates the first encoder 9A, “J2” indicates the second encoder 9B, “J3” indicates the third encoder 9C, and “J4” indicates the fourth encoder 9D. In FIG. 6, “proc” indicates processing for generating a response signal.

First, at time T1, the driving control section 8A starts transmitting a request signal for requesting position information to the third encoder 9C via the first communication line 10A. At the time T1, the driving control section 8A starts transmitting, to the first encoder 9A via the second communication line 10B, a request signal for requesting the monitoring section 8B to transmit position information. A required time from a start to completion of the transmission of the request signal is, for example, approximately 5 μs.

Subsequently, at time T2, the transmission of the request signal to the first encoder 9A and the third encoder 9C is completed and the first encoder 9A and the third encoder 9C start generation of signals concerning the position information. At time T3 after, for example, 10 μs, the first encoder 9A starts transmitting a response signal to the monitoring section 8B and the third encoder 9C starts transmitting a response signal to the driving control section 8A.

At the time T3, the monitoring section 8B starts reception of the response signal from the first encoder 9A and the driving control section 8A starts reception of the response signal from the third encoder 9C. At time T4 after, for example, 8 μs, the reception of the response signal is completed. Received information is stored in the memories.

A time period of, for example, 8.25 μs elapses from the time T4 until the next processing is executed. A cycle to this point is a quarter cycle in a control cycle. A required time of the quarter cycle is 31.25 μs. Thereafter, a required time at every quarter cycle is the same. A reception time, a transmission time, and a processing time are the same as those explained above.

Subsequently, at time T5 after 8.25 μs, the driving control section 8A starts transmitting a request signal for requesting position information to the fourth encoder 9D via the first communication line 10A. At the time T5, the driving control section 8A starts transmitting, to the second encoder 9B via the second communication line 10B, a request signal for requesting the monitoring section 8B to transmit position information.

Subsequently, at time T6, the transmission of the request signals to the second encoder 9B and the fourth encoder 9D is completed and the second encoder 9B and the fourth encoder 9D start generation of signals concerning the position information. At time T7, the second encoder 9B starts transmitting a response signal to the monitoring section 8B and the fourth encoder 9D starts transmitting a response signal to the driving control section 8A. At time T8, reception of the response signals is completed. Received information is stored in the memories.

Subsequently, at time T9 after 8.25 μs, the driving control section 8A starts transmitting a request signal for requesting position information to the first encoder 9A via the first communication line 10A. At the time T9, the driving control section 8A starts transmitting, to the third encoder 9C via the second communication line 10B, a request signal for requesting the monitoring section 8B to transmit position information.

Subsequently, at time T10, the transmission of the request signals to the first encoder 9A and the third encoder 9C is completed and the first encoder 9A and the third encoder 9C start generation of signals concerning the position information. At time T11, the third encoder 9C starts transmitting a response signal to the monitoring section 8B and the first encoder 9A starts transmitting a response signal to the driving control section 8A. At time T12, reception of the response signals is completed. Received information is stored in the memories.

Subsequently, at time T13 after 8.25 μs, the driving control section 8A starts transmitting a request signal for requesting position information to the second encoder 9B via the first communication line 10A. At the time T13, the driving control section 8A starts transmitting, to the fourth encoder 9D via the second communication line 10B, a request signal for requesting the monitoring section 8B to transmit position information.

Subsequently, at time 114, the transmission of the request signals to the second encoder 9B and the fourth encoder 9D is completed and the second encoder 9B and the fourth encoder 9D start generation of signals concerning the position information. At time T15, the second encoder 9B starts transmitting a response signal to the monitoring section 8B and the fourth encoder 9D starts transmitting a response signal to the driving control section 8A. At time T16, reception of the response signals is completed. Received information is stored in the memories.

In this way, the driving control section 8A transmits the request signals to the first to fourth encoders 9A to 9D in a time division manner via the first communication line 10A and receives the response signals from the first to fourth encoders 9A to 9D in a time division manner via the first communication line 10A. The monitoring section 8B receives the response signals from the first to fourth encoders 9A to 9D in a time division manner via the second communication line 10B. That is, the driving control section 8A, the monitoring section 8B, and the first to fourth encoders 9A to 9D perform communication in a time division manner by the half duplex communication. Consequently, it is possible to suppress the number of wires of the first communication line 10A and the second communication line 10B from increasing.

After finishing receiving all of the response signals from the first to fourth encoders 9A to 9D, that is, when one cycle in the control cycle passes, the driving control section 8A calculates a position and a posture of the robot arm 20 based on the response signals and outputs the next command. According to repetition of such control, the robot arm 20 can perform a desired operation.

After finishing receiving all of the response signals from the first to fourth encoders 9A to 9D, that is, when one cycle in the control cycle passes, as explained above, the monitoring section 8B calculates speed of the control point TCP based on the response signals and determines whether the speed is equal to or lower than predetermined speed and determines whether the arms 22 to 24 have moved as commanded. According to repetition of such control, it is possible to secure safety of the robot arm 20.

As explained above, in the robot system 100, when the driving control section 8A is performing communication with the third encoder 9C, the monitoring section 8B performs communication with the first encoder 9A, when the driving control section 8A is performing communication with the fourth encoder 9D, the monitoring section 8B performs communication with the second encoder 9B, when the driving control section 8A is performing communication with the first encoder 9A, the monitoring section 8B performs communication with the third encoder 9C, and, when the driving control section 8A is performing communication with the third encoder 9C, the monitoring section 8B performs communication with the first encoder 9A.

As explained above, in this embodiment, the driving control section 8A simultaneously performs communication for transmitting the request signal for requesting position information to the third encoder 9C via the first communication line 10A and communication for transmitting, to the first encoder 9A via the second communication line 10B, the request signal for requesting the monitoring section 8B to transmit position information, in a temporally overlapping manner.

The driving control section 8A simultaneously performs communication for transmitting the request signal for requesting position information to the fourth encoder 9D via the first communication line 10A and communication for transmitting, to the second encoder 9B via the second communication line 10B, the request signal for requesting the monitoring section 8B to transmit position information.

The driving control section 8A simultaneously performs communication for transmitting the request signal for requesting position information to the first encoder 9A via the first communication line 10A and communication for transmitting, to the third encoder 9C via the second communication line 10B, the request signal for requesting the monitoring section 8B to transmit position information.

The driving control section 8A simultaneously performs communication for transmitting the request signal for requesting position information to the second encoder 9B via the first communication line 10A and communication for transmitting, to the fourth encoder 9D via the second communication line 10B, the request signal for requesting the monitoring section 8B to transmit position information.

When the communication performed by the driving control section 8A via the first communication line 10A in this way is represented as first communication and the communication performed by the driving control section 8A via the second communication line 10B in this way is represented as second communication, the driving control section 8A performs the first communication and the second communication in a temporally overlapping manner. Consequently, since the first communication and the second communication temporally overlap, it is possible to reduce a required time until the driving control section 8A and the monitoring section 8B finish acquiring position information of all of the first to fourth encoders 9A to 9D. In particular, in the present disclosure, in order to reduce the number of wires, the driving control section 8A, the monitoring section 8B, and the first to fourth encoders 9A to 9D are configured to respectively perform communication in a time division manner by the half duplex communication. In the case of such a configuration, when communication of the driving control section 8A and the first to fourth encoders 9A to 9D and communication of the monitoring section 8B and the first to fourth encoders 9A to 9D are respectively performed in a time division manner, a required time until the driving control section 8A and the monitoring section 8B finish acquiring position information of all of the first to fourth encoders 9A to 9D is relatively long. In contrast, in the present disclosure, although the number of wires is reduced by the half duplex communication, by performing the first communication and the second communication in a temporally overlapping manner, it is possible to reduce the required time until the driving control section 8A and the monitoring section 8B finish acquiring position information of all of the first to fourth encoders 9A to 9D. Consequently, according to the present disclosure, it is possible to achieve both of a reduction in the number of wires and a reduction in a communication time.

A start time of the first communication and a start time of the second communication coincide and an end time of the first communication and an end time of the second communication coincide. Consequently, it is possible to more effectively reduce the communication time.

In the above explanation, the start times of the first communication and the second communication coincide and the end times of the first communication and the second communication coincide. However, the present disclosure is not limited to this. One or both of the start times and the end times may deviate if at least parts of the first communication and the second communication temporally overlap.

The first communication and the second communication have a control cycle deviation of a half cycle. Specifically, as shown in FIG. 6, in a period of the time T1 to the time T9, that is, in a period of the half cycle of the control cycle, the monitoring section 8B performs communication with the first encoder 9A and the second encoder 9B and the driving control section 8A performs communication with the third encoder 9C and the fourth encoder 9D. With such a configuration, the driving control section 8A and the monitoring section 8B share the receive position information, whereby the position information of the first to fourth encoders 9A to 9D can be acquired in the period of the half cycle of the control cycle. As a result, it is possible to more accurately drive the robot arm 20 and further increase a frequency of monitoring safety.

In this embodiment, the control cycle is a double of the control cycle of the related art. When signals of a plurality of encoders are multiplexed in a time division manner, the number of encoders is limited by a communication cycle and a communication band. Therefore, by doubling the control cycle, it is possible to secure a time period necessary for communication and increase the number of encoders.

As explained above, the robot system 100 according to the present disclosure includes the robot arm 20 including the first arm and the second arm, the first position detecting section that detects the position of the first arm, and the second position detecting section that detects the position of the second arm, the driving control section 8A that controls the driving of the robot arm 20 based on the position information output by the first position detecting section and the second position detecting section, the monitoring section 8B that determines, based on the position information, whether the operation of the robot arm 20 is normal, the first communication line 10A for coupling the driving control section 8A and the first position detecting section and coupling the driving control section 8A and the second position detecting section to perform the half duplex communication, and the second communication line 10B for coupling the monitoring section 8B and the driving control section 8A, coupling the monitoring section 8B and the first position detecting section, and coupling the monitoring section 8B and the second position detecting section to perform the half duplex communication. The driving control section 8A performs the first communication with the first position detecting section via the first communication line 10A and the second communication with the second position detecting section via the second communication line 10B in a temporally overlapping manner. As the “first arm” and the “second arm”, any two among the arms 22 to 24 can be applied. As the “first position detecting section” and the “second position detecting section”, among the first to fourth encoders 9A to 9D, the encoders that detect the position of the arms selected as the “first arm” and the “second arm” can be applied.

With such a configuration, since the half duplex communication is performed via the first communication line 10A and the second communication line 10B, it is possible to reduce the number of wires. Although the number of wires is reduced by the half duplex communication, since the first communication and the second communication are performed in a temporally overlapping manner, the required time until the driving control section 8A and the monitoring section 8B finish acquiring the position information of both of the first position detecting section and the second position detecting section can be reduced. Consequently, according to the present disclosure, it is possible to achieve both of a reduction in the number of wires and a reduction in a communication time.

### Second Embodiment

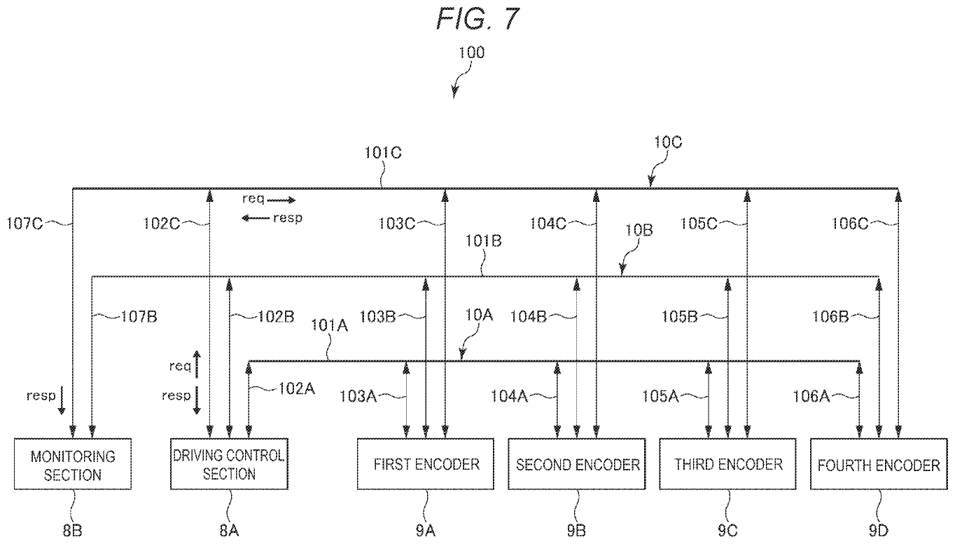

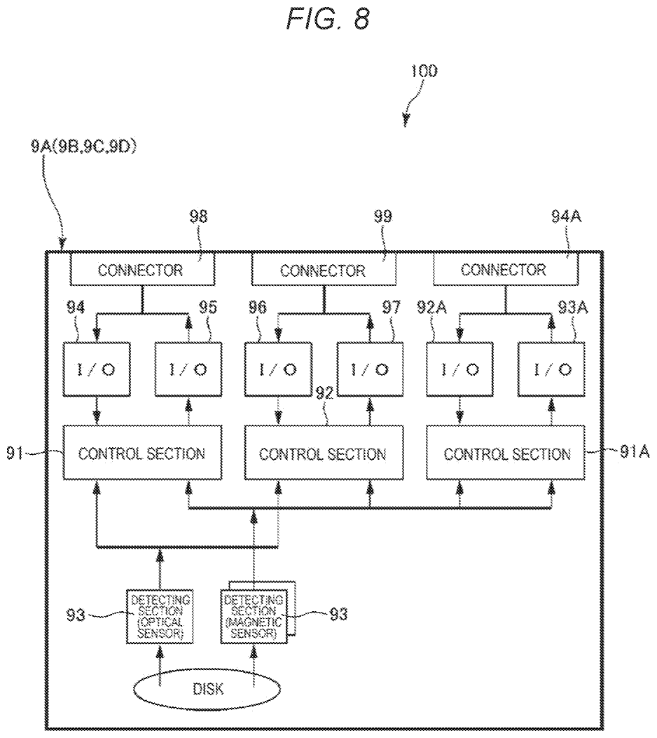

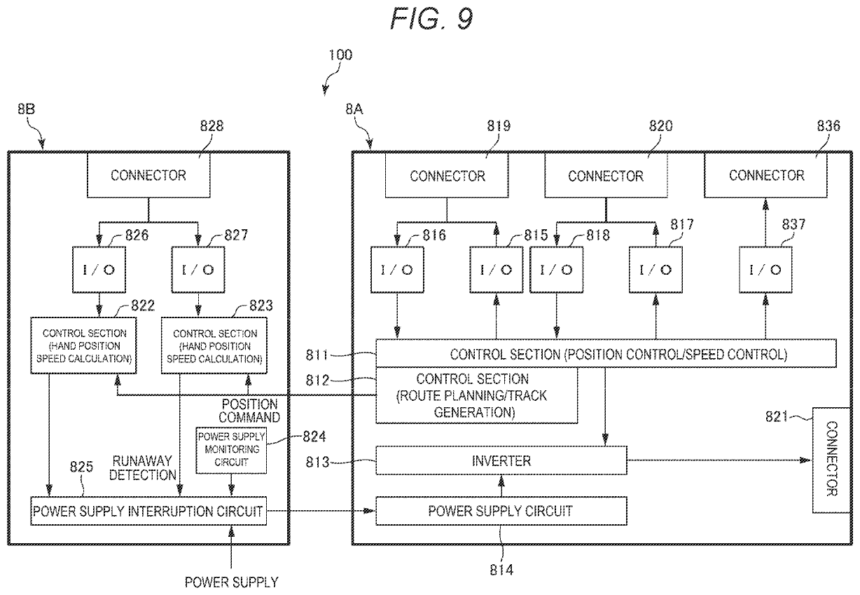

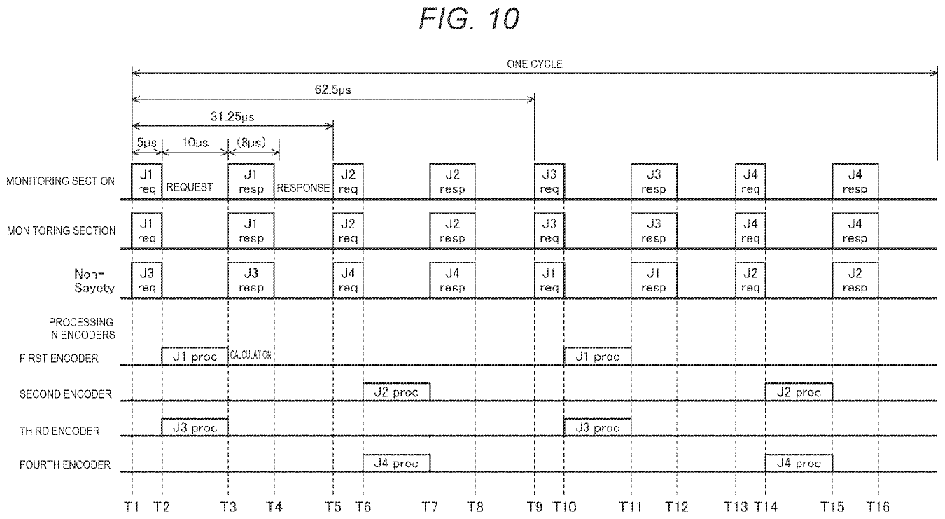

FIG. 7 is a diagram for explaining a coupling scheme for an encoder, a driving control section, and a monitoring section included in a second embodiment of the robot system according to the present disclosure. FIG. 8 is a functional block diagram of the encoder shown in FIG. 7. FIG. 9 is a functional block diagram of the driving control section and the monitoring section shown in FIG. 7. FIG. 10 is a timing chart showing communication timings of the encoder, the driving control section, and the monitoring section shown in FIG. 7.

The second embodiment of the robot system according to the present disclosure is explained below with reference to FIGS. 7 to 10. However, differences from the first embodiment are mainly explained and explanation of similarities to the first embodiment is omitted.

As shown in FIG. 7, the robot system 100 includes a third communication line 10C. The first to fourth encoders 9A to 9D, the driving control section 8A, and the monitoring section 8B are coupled to one another by the third communication line 10C. The third communication line 10C includes a bus 101C and a wire 102C, a wire 103C, a wire 104C, a wire 105C, a wire 106C, and a wire 107C coupled to the bus 101C.

The wire 102C couples the bus 101C and the driving control section 8A. The wire 103C couples the bus 101C and the first encoder 9A. The wire 104C couples the bus 101C and the second encoder 9B. The wire 105C couples the bus 101C and the third encoder 9C. The wire 106C couples the bus 101C and the fourth encoder 9D. The wire 107C couples the bus 101C and the monitoring section 8B.

The first encoder 9A further includes a control section 91A, an I/O interface 92A, an I/O interface 93A, and a connector 94A in addition to the components explained in the first embodiment.

The control section 91A includes a processor and a memory. The processor is configured by, for example, a CPU (Central Processing Unit) and can read and execute various programs stored in the memory. The memory stores various programs and the like executable by the processor. Examples of the memory include a volatile memory such as a RAM (Random Access Memory), a nonvolatile memory such as a ROM (Read Only Memory), and a memory including a volatile region and a nonvolatile region.

The control section 91A receives a signal output from the detecting section 93 and calculates a rotation amount of the motor 41.

The I/O interface 92A performs communication with the monitoring section 8B via the third communication line 10C, receives a request signal, and inputs the request signal to the control section 91A.

The I/O interface 93A performs communication with the monitoring section 8B via the third communication line 10C and transmits a response signal, that is, a position signal output from the control section 91A.

The connector 94A is a coupling section to which the third communication line 10C is coupled. The connector 94A is a connector of the standard corresponding to the wire for performing the serial communication.

Such a configuration is the same concerning the second to fourth encoders 9B to 9D.

The driving control section 8A further includes a connector 836 and an I/O interface 837 in addition to the components explained in the first embodiment.

The connector 836 is a coupling section to which the second communication line 10B is coupled. The connector 836 is a connector of the standard corresponding to the wire for performing the serial communication.

The I/O interface 837 performs communication with the first encoder 9A, the second encoder 9B, the third encoder 9C, and the fourth encoder 9D via the second communication line 10B and transmits request signals for requesting position information respectively to the first encoder 9A, the second encoder 9B, the third encoder 9C, and the fourth encoder 9D.

The monitoring section 8B further includes the connector 836 in addition to the components explained in the first embodiment. The connector 836 is a coupling section to which the second communication line 10B is coupled. The connector 836 is a connector of the standard corresponding to the wire for performing the serial communication.

The monitoring section 8B compares the position information received from the second communication line 10B and the position information received from the third communication line 10C. If the position information received from the second communication line 10B and the position information received from the third communication line 10C do not coincide, the monitoring section 8B regards that a failure has occurred in any one of the first to fourth encoders 9A to 9D. Consequently, it is possible to further improve the reliability.

As shown in FIG. 10, timing when the monitoring section 8B performs communication with the first to fourth encoders 9A to 9D using the second communication line 10B and timing when the monitoring section 8B performs communication with the first to fourth encoders 9A to 9D using the third communication line 10C coincide.

In this way, in this embodiment, the first to fourth encoders 9A to 9D and the monitoring section 8B are coupled by the second communication line 10B and the third communication line 10C. That is, wires for coupling the first to fourth encoders 9A to 9D and the monitoring section 8B are duplexed.

The fact that the first to fourth encoders 9A to 9D and the monitoring section 8B are coupled by the two communication lines is considered as that the second communication line 10B is duplexed. The second communication line 10B is duplexed, whereby, even if disconnection occurs in one communication line, it is possible to perform communication using the other communication line and perform the control explained in the first embodiment. Therefore, it is possible to further improve the reliability.

### Third Embodiment

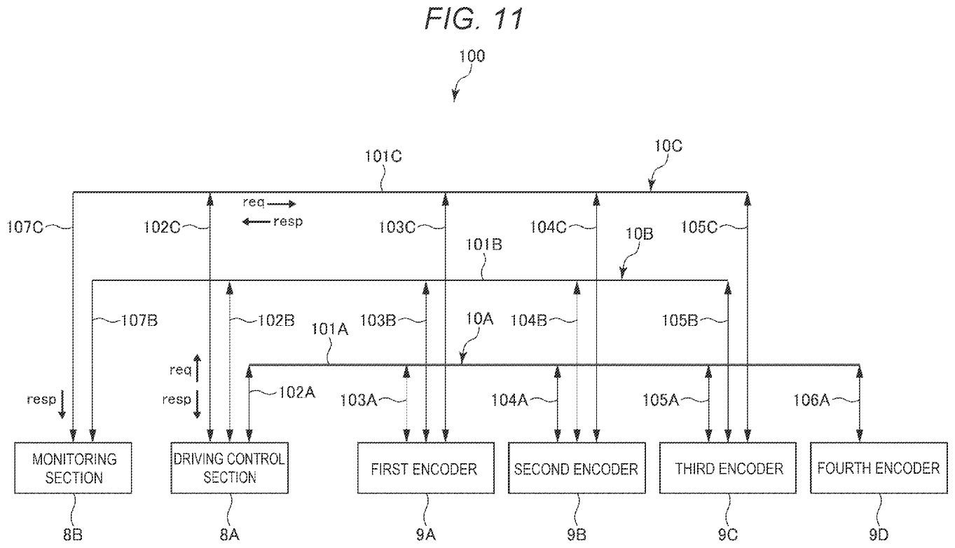

FIG. 11 is a diagram for explaining a coupling scheme for an encoder, a driving control section, and a monitoring section included in a third embodiment of the robot system according to the present disclosure.

The third embodiment of the robot system according to the present disclosure is explained below with reference to FIG. 11. However, differences from the embodiments explained above are mainly explained and explanation of similarities to the embodiments is omitted.

As shown in FIG. 11, in this embodiment, only the first communication line 10A is coupled to the fourth encoder 9D. Coupling of the second communication line 10B and the third communication line 10C is not shown.

The robot 2 includes the arm 24, which is a third arm, located on the distal end side with respect to the arm 22, which is the first arm, and the arm 23, which is the second arm, and a third position detecting section that detects the position of the arm 24. Only one of the first communication line 10A and the second communication line 10B, in a configuration shown in FIG. 11, only the first communication line 10A is coupled to the third position detecting section. As the “second position detecting section” explained above, the third encoder 9C or the fourth encoder 9D can be applied. With such a configuration, it is possible to further reduce the number of wires. In particular, the arm 24 on the distal end side has a smaller movable range compared with the arm 22 and the arm 23. Therefore, the arm 24 may have slightly lower position accuracy. The internal space of the arm 24 on the distal end side is smaller compared with the arm 22 and the arm 23. Therefore, by reducing wires for the arm 24, it is possible to reduce the number of wires while suppressing deterioration in position accuracy of the robot arm 20 as much as possible. It is possible to reduce the arm 24 on the distal end side in size.

The second communication line 10B is duplexed. The first communication line 10A is coupled to the third position detecting section. By omitting coupling of the duplexed second communication line 10B and the third position detecting section in this way, it is possible to more effectively reduce the number of wires.

### Fourth Embodiment

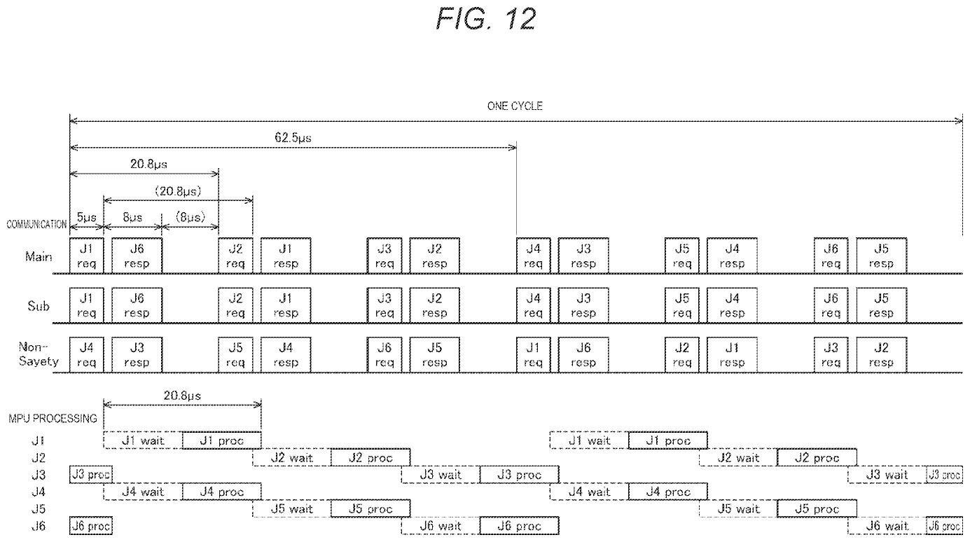

FIG. 12 is a timing chart showing communication timings of an encoder, a driving control section, and a monitoring section included in a fourth embodiment of the robot system according to the present disclosure.

In this embodiment, although not shown in FIG. 12, the robot 2 is a six-axis robot. That is, the robot 2 includes a first arm, a second arm, a third arm, a fourth arm, a fifth arm, and a sixth arm, a first position detecting section that detects the position of the first arm, a second position detecting section that detects the position of the second arm, a third position detecting section that detects the position of the third arm, a fourth position detecting section that detects the position of the fourth arm, a fifth position detecting section that detects the position of the fifth arm, and a sixth position detecting section that detects the position of the sixth arm.

Communication of the driving control section 8A, the monitoring section 8B, and the first to sixth position detecting sections is performed at timings shown in FIG. 12. In FIG. 12, “J1” indicates the first position detecting section, “J2” indicates the second position detecting section, “J3” indicates the third position detecting section, “J4” indicates the fourth position detecting section, “J5” indicates the fifth position detecting section, and “J6” indicates the sixth position detecting section.

When the monitoring section 8B is performing communication with the first position detecting section, the driving control section 8A performs communication with the fourth position detecting section. When the monitoring section 8B is performing communication with the second position detecting section, the driving control section 8A performs communication with the fifth position detecting section. When the monitoring section 8B is performing communication with the third position detecting section, the driving control section 8A performs communication with the sixth position detecting section. When the monitoring section 8B is performing communication with the fourth position detecting section, the driving control section 8A performs communication with the first position detecting section. When the monitoring section 8B is performing communication with the fifth position detecting section, the driving control section 8A performs communication with the second position detecting section. When the monitoring section 8B is performing communication with the sixth position detecting section, the driving control section 8A performs communication with the fourth position detecting section.

The driving control section 8A sequentially performs transmission of a request signal to the fourth position detecting section, reception of a response signal from the third position detecting section, transmission of a request signal to the fifth position detecting section, reception of a response signal from the fourth position detecting section, transmission of a request signal to the sixth position detecting section, reception of a response signal from the fifth position detecting section, transmission of a request signal to the first position detecting section, reception of a response signal from the sixth position detecting section, transmission of a request signal to the second position detecting section, reception of a response signal from the first position detecting section, transmission of a request signal to the third position detecting section, and reception of a response signal from the second position detecting section.

In this way, according to the present disclosure, it is possible to achieve a reduction in a communication time with the first to sixth position detecting sections while reducing the number of wires in the six-axis robot as well. In particular, when a long processing time for generating the response signal is required because the transmission of the request signal and the reception of the response signal is repeated for the different position detecting sections, it is possible to more effectively achieve a reduction in the communication time.

The robot system according to the present disclosure is explained based on the embodiments shown in the figures. However, the present disclosure is not limited to the embodiments. The components of the sections can be replaced with any components having the same functions. Any other components may be added to the robot system.

What is claimed is:

1. A robot system comprising:
a robot arm including a first arm, a second arm, a first position detecting section configured to detect a position of the first arm, and a second position detecting section configured to detect a position of the second arm;
a driving control section configured to control driving of the robot arm based on position information output by the first position detecting section and the second position detecting section;
a monitoring section configured to determine, based on the position information, whether an operation of the robot arm is normal;
a first communication line for coupling the driving control section and the first position detecting section and coupling the driving control section and the second position detecting section to perform half duplex communication; and
a second communication line for coupling the monitoring section and the driving control section, coupling the monitoring section and the first position detecting section, coupling the monitoring section and the second position detecting section to perform the half duplex communication, wherein
the driving control section performs first communication with the first position detecting section via the first communication line and second communication with the second position detecting section via the second communication line in a temporally overlapping manner.

2. The robot system according to claim 1, wherein the first communication and the second communication have a control cycle deviation of a half cycle.

3. The robot system according to claim 1, wherein a start time of the first communication and a start time of the second communication coincide and an end time of the first communication and an end time of the second communication coincide.

4. The robot system according to claim 1, wherein, when determining that the operation of the robot arm is abnormal, the monitoring section stops the operation of the robot arm.

5. The robot system according to claim 1, wherein the second communication line is duplexed.

6. The robot system according to claim 1, wherein
the robot arm includes a third arm located on a distal end side with respect to the first arm and the second arm and a third position detecting section configured to detect a position of the third arm, and
only one of the first communication line and the second communication line is coupled to the third position detecting section.

7. The robot system according to claim 6, wherein
the second communication line is duplexed, and
the first communication line is coupled to the third position detecting section.
